(19) United States
(12) Patent Application Publication
(10) Pub. No.: US 2021/0290474 A1
(43) Pub. Date: Sep. 23, 2021

(54) PELVIS CONTROL AND RETRAINING HARNESS SYSTEM AND METHOD

(71) Applicant: NGU Labs, LLC, Palos Hills, IL (US)

(72) Inventors: Tomas Dockus, Kaunas (LT); John O'Connor, Downers Grove, IL (US)

(21) Appl. No.: 17/199,638

(22) Filed: Mar. 12, 2021

Related U.S. Application Data
(60) Provisional application No. 62/990,953, filed on Mar. 17, 2020.

(51) Int. Cl. A61H 3/00

(52) U.S. Cl. CPC A61H 3/008; A61H 2201/1621; A61H 2201/1652; A61H 2205/088; A61H 2205/10; A61H 2003/007

(57) ABSTRACT

A harness system is described for rehabilitating and retraining a patient, such as that may be experiencing neurological disorders, through controlling a patient's pelvis and/or body. Rehabilitation and retraining exercises may be facilitated for patients carrying out routine daily activities. An illustrative system may include a pelvic harness, a trainer's/therapist's belt, a pelvis support strap, a lumbar thoracic belt, thigh cuffs, a knee-ankle support system, ankle cuffs, and straps. Also provided is a method for rehabilitating and retraining a patient using an improved pelvis control system.

### CROSS-REFERENCE TO RELATED APPLICATION

This application claims the priority from U.S. provisional patent application Ser. No. 62/990,953 filed Mar. 17, 2020. The foregoing application is incorporated in its entirety herein by reference.

### FIELD OF THE INVENTION

The present disclosure relates to a harness system. More particularly, the disclosure relates to a harness system for controlling the pelvis of a patient, which may facilitate retraining pelvic movement.

### BACKGROUND

Conventional rehabilitation and retraining systems are expensive. As a notable disadvantage, conventional rehabilitation and retraining systems provide for a limited number of movements and uses and, therefore, are limited in their utility. Furthermore, conventional rehabilitation and retraining systems require significant time and other resources to set up, take-down, and transport.

Therefore, a need exists to solve the deficiencies present in the prior art. What is needed is a rehabilitation and retraining system that is affordable to a wide range of the consuming public. What is needed is a rehabilitation and retraining system that is dynamic and can be adapted for use in many ways. What is needed is a rehabilitation and retraining system that does not require significant time to set up, take down, and otherwise transport and is able to be deployed more efficiently.

### SUMMARY

An aspect of the disclosure advantageously provides a rehabilitation and retraining system that is affordable to a wide range of the consuming public. An aspect of the disclosure advantageously provides a rehabilitation and retraining system that is dynamic and can be adapted for use in many ways. An aspect of the disclosure advantageously provides a rehabilitation and retraining system that does not require significant time to set up, take down, and otherwise transport and is able to be deployed more efficiently.

A system enabled by this disclosure may facilitate and/or provide for rehabilitation and retraining of a patient experiencing physical and/or neurological limitations, such as those caused by neurological disorders. A system enabled by this disclosure may constitute an improvement in a number of respects relative to conventional pelvic control rehabilitation/retraining systems. Due to the modular design of various embodiments provided throughout this disclosure, the nature of a system enabled by this disclosure may advantageously reduce costs to create and, therefore, ultimately be more affordable. A system enabled by this disclosure may also be more dynamic than conventional systems in that such an enabled system may be used to perform a wider range of movements than conventional systems. The present disclosure further provides embodiments that may contribute to greater efficiencies in the rehabilitation/retraining process in a number of respects, including because less resources are necessary to set up, take down, and transport the system than with conventional systems.

Accordingly, the disclosure may feature a physical training assistance system including a pelvic harness and connective components. The pelvic harness may be removably installable to a lower back region of a body. The pelvic harness may include a harness member, which may include a harness middle portion to align near the lower back region when worn, a harness waist member extending outwardly from the harness middle portion to at least partially pass around a waist region of the body, and a harness thigh member extending outwardly from the harness middle portion to at least partially pass around a thigh region of the body. The pelvic harness may further include a strap holding member installed to the harness middle portion, a handle installed to the harness member, a thigh strap installed to the harness thigh member, a first thigh strap attachment interface adjustably installed to the thigh strap, a second thigh strap attachment interface installed to the harness waist member to selectively connect to the first thigh strap attachment interface, and a ring strap securing interface installed to the harness middle portion. The connective components may be removably installable to the pelvic harness. The connective components may include a lumbar support strap removably attachable to the pelvic harness via the strap holding member, and a ring strap removably connected to the pelvic harness via passing through the ring strap securing interface.

In another aspect, the harness waist member may have a harness waist member width that substantially continually decreases in width as a distance from the harness middle portion increases.

In another aspect, the strap holding member may include a first hook and loop interface. The lumbar support strap may include a second hook and loop interface removably installable to the first hook and loop interface. When connected, sliding movement of the lumbar support strap may be reduced upon installing the lumbar support strap to the harness member via the strap holding member.

In another aspect, the lumbar support strap may include lumbar support ends. Lumbar support rings may be installed at the lumbar support ends.

In another aspect, the pelvic harness further may include an accessory attachment interface installed on the harness waist member to receive at least one of the connective components.

In another aspect, the connective components further may include a leg member, which may further include a leg cuff to at least partially pass around a leg region of the body and a leg strap removably attached to the leg cuff via passing through a leg cuff sleeve attached to the leg cuff.

In another aspect, the leg cuff may include a leg cuff body member having a first leg cuff attachment interface. The leg cuff may also include a leg cuff securing member extending outwardly from the leg cuff body member having a second leg cuff attachment interface. The first leg cuff attachment interface and the second leg cuff attachment interface may be removably joinable to secure the leg cuff to the leg region.

In another aspect, an ankle-knee member may be included having an ankle-knee member body that may include a top ankle-knee member body portion having a first ankle-knee member width, a bottom ankle-knee member portion having a second ankle-knee member width that is less than the first ankle-knee member width, and a middle ankle-knee member body portion having a third ankle-knee member width that is less than the second ankle-knee member width. A surface padding may be applied to at least part of the ankle-knee member body. An ankle-knee member strap attachment interface may be provided to receive the connective components.

In another aspect, the handle further may include a handle strap installed to the harness member. An outer handle member may substantially enclose at least part of the handle strap. The handle strap may be passed through an open handle interior space of the outer handle member to form the handle.

According to an embodiment of this disclosure, a physical training assistance system may be provided including a pelvic harness and connective components. The pelvic harness may be removably installable to a lower back region of a body. The pelvic harness may include a harness member including a harness middle portion to align near the lower back region when worn, a harness waist member extending outwardly from the harness middle portion to at least partially pass around a waist region of the body, and a harness thigh member extending outwardly from the harness middle portion to at least partially pass around a thigh region of the body. The pelvic harness may additionally include a strap holding member including a first hook and loop interface installed to the harness middle portion, a handle installed to the harness member, an accessory attachment interface installed on the harness waist member to receive at least one of the connective components, and a ring strap securing interface installed to the harness middle portion. The connective components may be removably installable to the pelvic harness. The connective components may include a lumbar support strap including a second hook and loop interface removably installable to the first hook and loop interface, the lumbar support strap being removably attachable to the pelvic harness via the strap holding member, a ring strap removably connected to the pelvic harness via passing through the ring strap securing interface, and leg member. The leg member may include a leg cuff to at least partially pass around a leg region of the body and a leg strap removably attached to the leg cuff via passing through a leg cuff sleeve attached to the leg cuff.

In another aspect, the harness waist member may have a harness waist member width that substantially continually decreases in width as a distance from the harness middle portion increases.

In another aspect, the pelvic harness further may include a thigh strap installed to the harness thigh member, a first thigh strap attachment interface adjustably installed to the thigh strap, and a second thigh strap attachment interface installed to the harness waist member to selectively connect to the first thigh strap attachment interface.

In another aspect, the leg cuff may include a leg cuff body member having a first leg cuff attachment interface and a leg cuff securing member extending outwardly from the leg cuff body member having a second leg cuff attachment interface. The first leg cuff attachment interface and the second leg cuff attachment interface may be removably joinable to secure the leg cuff to the leg region.

In another aspect, an ankle-knee member may be provided including an ankle-knee member body including a top ankle-knee member body portion having a first ankle-knee member width, a bottom ankle-knee member portion having a second ankle-knee member width that is less than the first ankle-knee member width, and a middle ankle-knee member body portion having a third ankle-knee member width that is less than the second ankle-knee member width. A surface padding may be applied to at least part of the ankle-knee member body. An ankle-knee member strap attachment interface may be provided to receive the connective components.

According to an embodiment of this disclosure, a method of physical training using a physical training assistance system is provided. The method may include (a) removably installing a pelvic harness to a lower back region of a body. The pelvic harness may include a harness member, which may further include a harness middle portion to align near the lower back region when worn, a harness waist member extending outwardly from the harness middle portion to at least partially pass around a waist region of the body, and a harness thigh member extending outwardly from the harness middle portion to at least partially pass around a thigh region of the body. The pelvic harness may also include a strap holding member installed to the harness middle portion, a handle installed to the harness member, and a thigh strap installed to the harness thigh member.

The method may include (b) adjustably installing a first thigh strap attachment interface of the thigh strap to a second thigh strap attachment interface of the harness waist member. The method may include (c) removably connecting a ring strap to the pelvic harness via passing through a ring strap securing interface of the harness middle portion. The method may include (d) removably installing connective components to the pelvic harness, the connective components including a lumbar support strap removably attachable to the pelvic harness via the strap holding member and the ring strap.

In another aspect, the strap holding member may include a first hook and loop interface. The method may further include (e) removably installing the lumbar support strap to the pelvic harness via attaching a second hook and loop interface of the lumbar support strap to the first hook and loop interface. Sliding movement of the lumbar support strap may be reduced upon installing the lumbar support strap to the harness member via the strap holding member.

In another aspect, the method may include (f) installing lumbar support rings at lumbar support ends of the lumbar support strap.

In another aspect, the method may include (g) installing at least one of the connective components to the pelvic harness via an accessory attachment interface of the harness waist member.

In another aspect, the connective components may include a leg member comprising a leg cuff to at least partially pass around a leg region of the body. The leg cuff may further include a leg cuff body member having a first leg cuff attachment interface and a leg cuff securing member extending outwardly from the leg cuff body member having a second leg cuff attachment interface. A leg strap may be removably attached to the leg cuff via passing through a leg cuff sleeve attached to the leg cuff. The method may further include (h) removably joining the first leg cuff attachment interface and the second leg cuff attachment interface to secure the leg cuff to the leg region.

In another aspect, the method may include (i) removably installing an ankle-knee member to the pelvic member. The ankle-knee member may include an ankle-knee member body including a top ankle-knee member body portion having a first ankle-knee member width, a bottom ankle-knee member portion having a second ankle-knee member width that is less than the first ankle-knee member width, and a middle ankle-knee member body portion having a third ankle-knee member width that is less than the second ankle-knee member width. The ankle-knee member may include a surface padding applied to at least part of the ankle-knee member body and an ankle-knee member strap attachment interface to receive the connective components.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a perspective view of an illustrative harness system showing a pelvic harness, according to an embodiment of this disclosure.

FIG. 2 is a perspective view of an illustrative lumbar support strap, according to an embodiment of this disclosure.

FIG. 3 is a perspective view of an illustrative thoracic belt and associated strap, according to an embodiment of this disclosure.

FIG. 4 is a top plan view of illustrative connective components, according to an embodiment of this disclosure.

FIG. 5 is a perspective view of an illustrative pelvic harness being worn by a user performing a physical training activity, according to an embodiment of this disclosure.

FIG. 6 is a perspective view of an illustrative embodiment of the lumbar support strap being worn by a user performing a physical training activity, according to an embodiment of this disclosure.

FIG. 7 is a perspective view of an illustrative pelvic harness being worn by a user performing a physical training activity, according to an embodiment of this disclosure.

FIG. 8 is a perspective view of an illustrative pelvic harness being worn by a user performing a physical training activity, according to an embodiment of this disclosure.

FIG. 9 is a perspective view of an illustrative leg member, according to an embodiment of this disclosure.

FIG. 10 is a perspective view of an illustrative leg member, according to an embodiment of this disclosure.

FIG. 11 is a perspective view an illustrative leg member being worn at a thigh region by a user performing a physical training activity, according to an embodiment of this disclosure.

FIG. 12 is a perspective view of an illustrative leg member being worn at an ankle region by a user performing a physical training activity, according to an embodiment of this disclosure.

FIG. 13 is a perspective view of an illustrative ankle-knee member, according to an embodiment of this disclosure.

FIG. 14 is a front elevation view of an illustrative ankle-knee member applied to a user, according to an embodiment of this disclosure.

FIG. 15 is a perspective view of an illustrative ankle-knee member in operation, according to an embodiment of this disclosure.

FIG. 16 is a perspective view of an alternative illustrative ankle-knee member, according to an embodiment of this disclosure.

### DETAILED DESCRIPTION

The following disclosure is provided to describe various embodiments of a pelvis control and retraining harness system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term pelvis, as it is used throughout this disclosure, is defined as the large bony structure near the base of the spine to which the legs are attached, such as in humans. The term harness, as it is used throughout this disclosure, is defined as set of straps and fittings that may be used, for example, to secure a patient to another person such as a trainer, physical therapist, or caregiver to virtually any object.

The term body, as it is used throughout this disclosure, is defined as an organized physical substance of an animal, such as a human. The term lower back region, as it is used throughout this disclosure, is defined as including or relating to a portion of a body adjacent to thoracic, lumbar, and sacrum portions of the spine. The term waist region, as it is used throughout this disclosure, is defined as including or relating to a portion of a body between about the rib cage and the hips. The term thigh region, as it is used throughout this disclosure, is defined as including or relating to a portion of a body between about the hips and the knee. The term leg region, as it is used throughout this disclosure, is defined as including or relating to a portion of a body between about the hips to the foot.

The term lumbar, as it is used throughout this disclosure, is defined as relating to the lower back. The term thoracic, as it is used throughout this disclosure, is defined as relating to the thorax. The term thorax, as it is used throughout this disclosure, is defined as the region of a human or other animal extending from the neck to the abdomen.

Various aspects of the present disclosure will now be described in detail, without limitation. In the following disclosure, a pelvis control and retraining harness system will be discussed. Those of skill in the art will appreciate alternative labeling of the pelvis control and retraining harness system as a rehabilitation system, retraining system, pelvic control system, physical therapy assistance system, the invention, or other similar names. Similarly, those of skill in the art will appreciate alternative labeling of the pelvis control and retraining harness system as a physical rehabilitation method, pelvic retraining operation, method for pelvic rehabilitation and physical therapy operation, method, operation, the invention, or other similar names. Skilled readers should not view the inclusion of any alternative labels as limiting in any way.

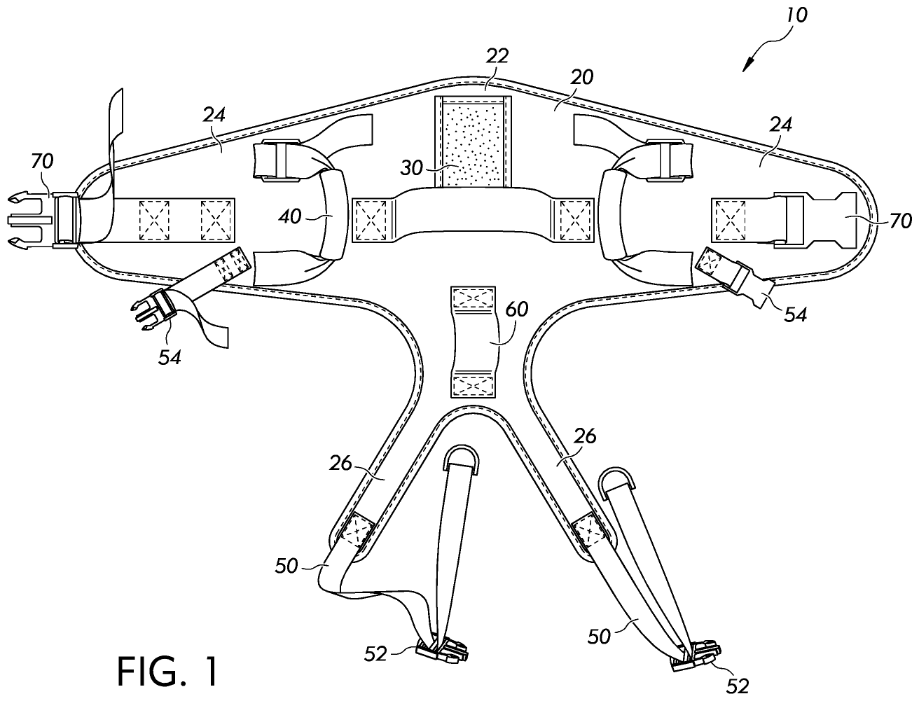

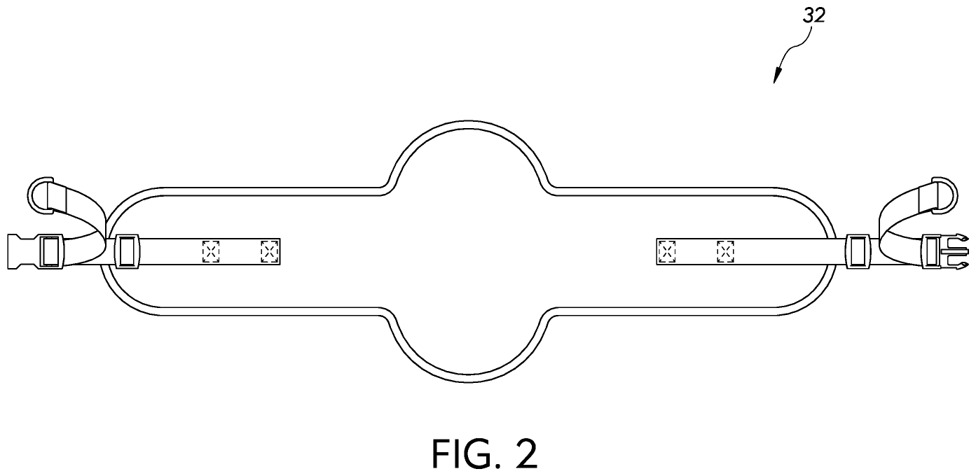

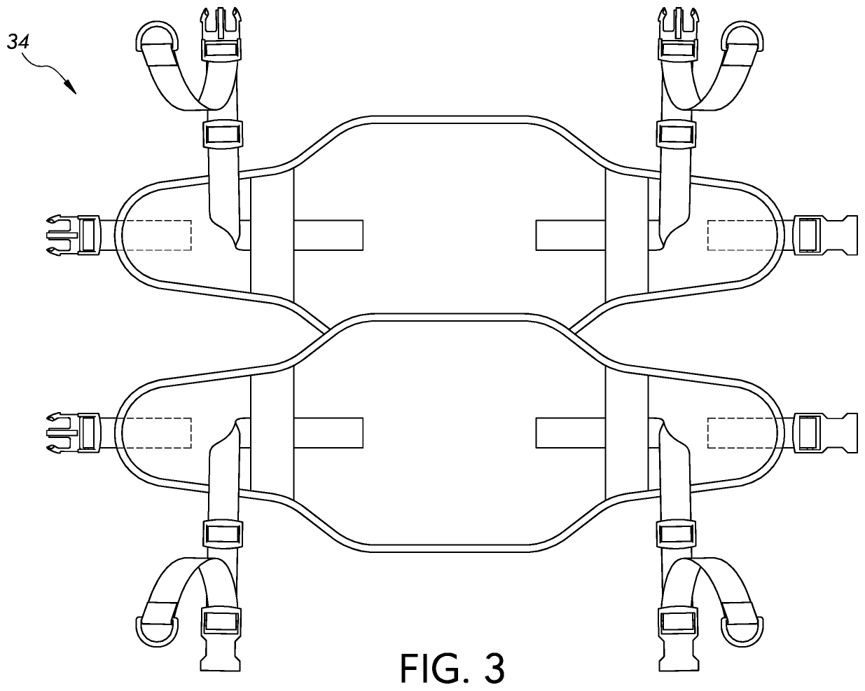

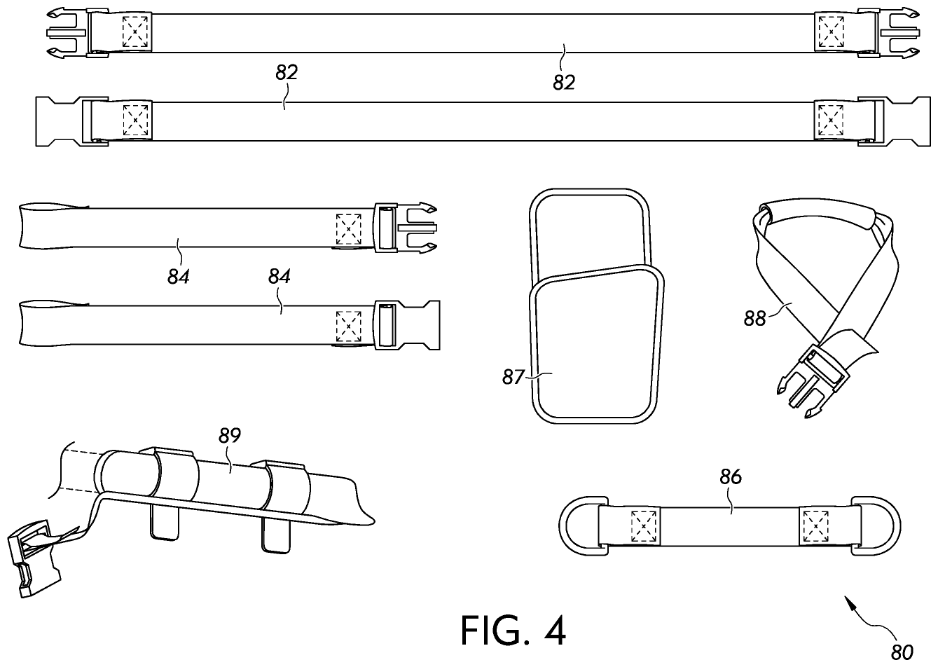

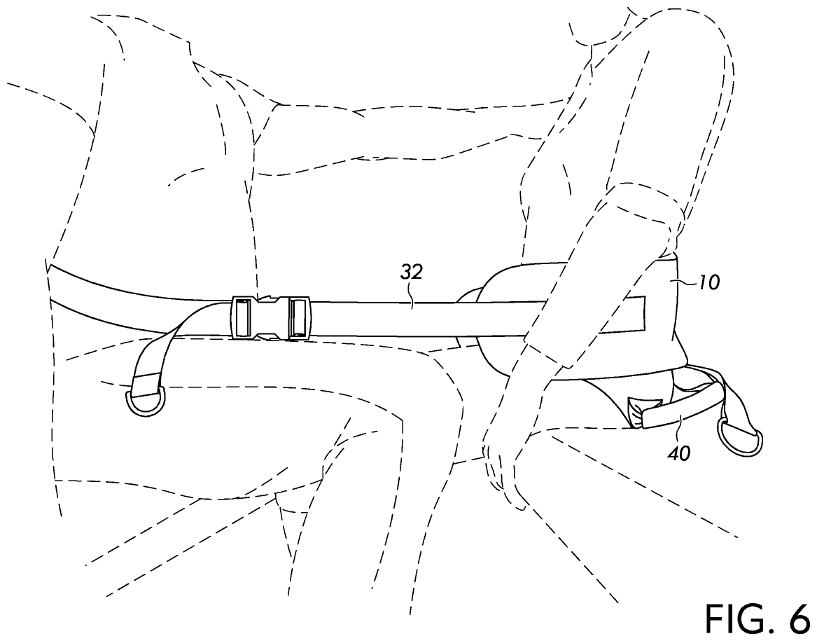

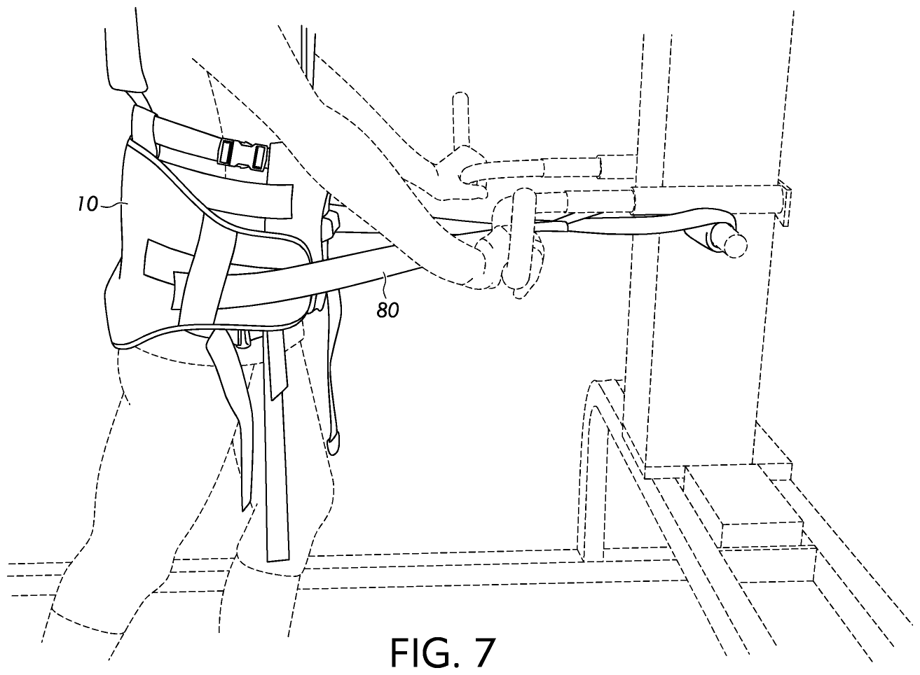

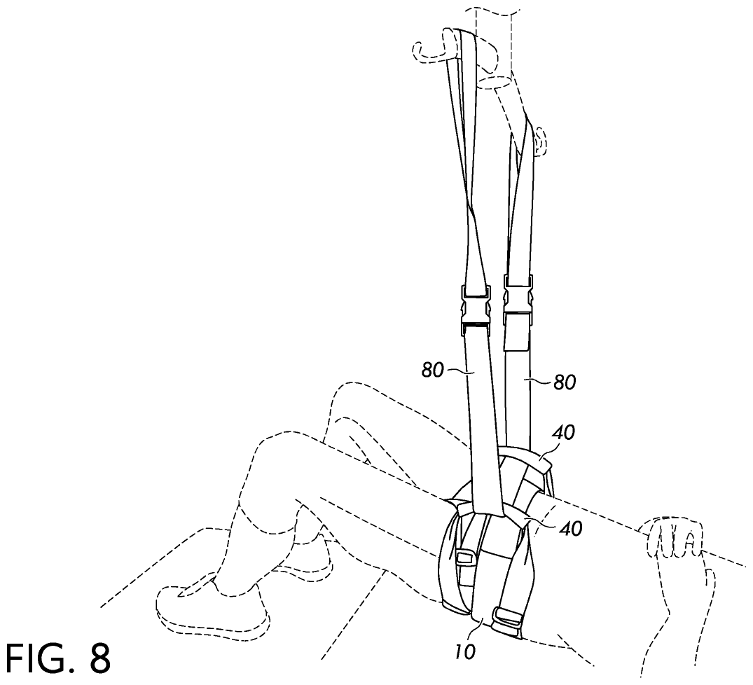

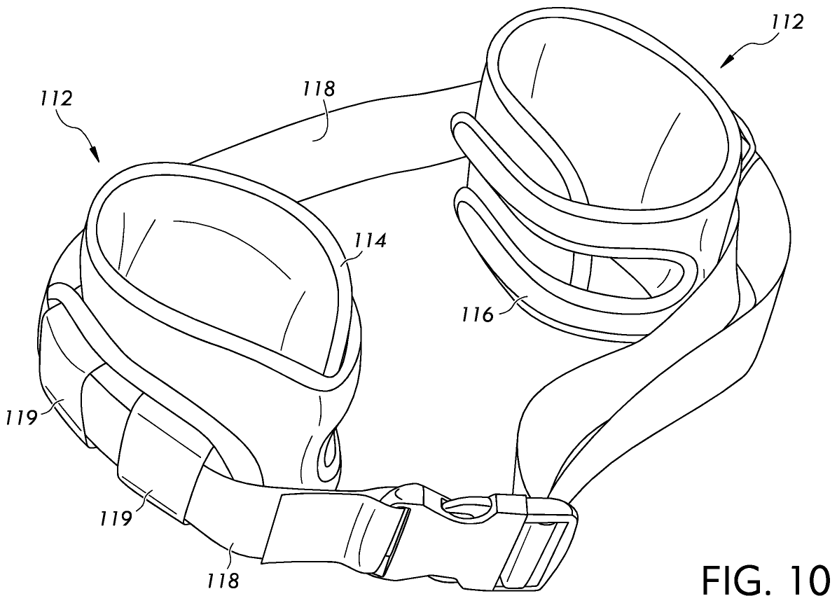

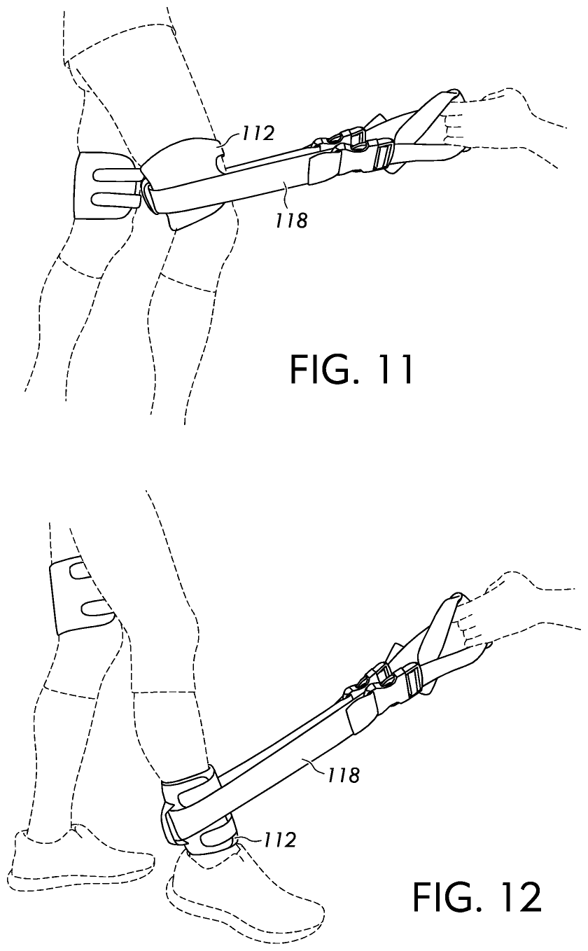

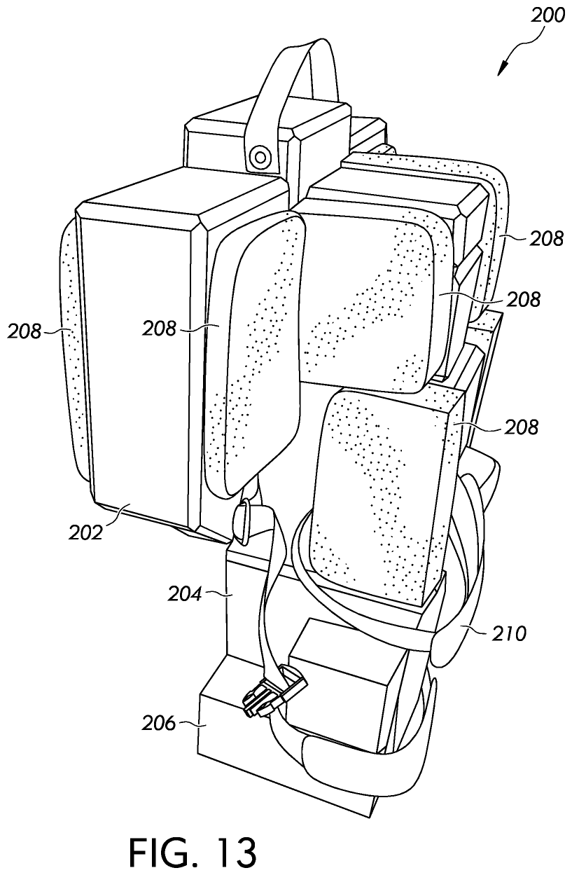

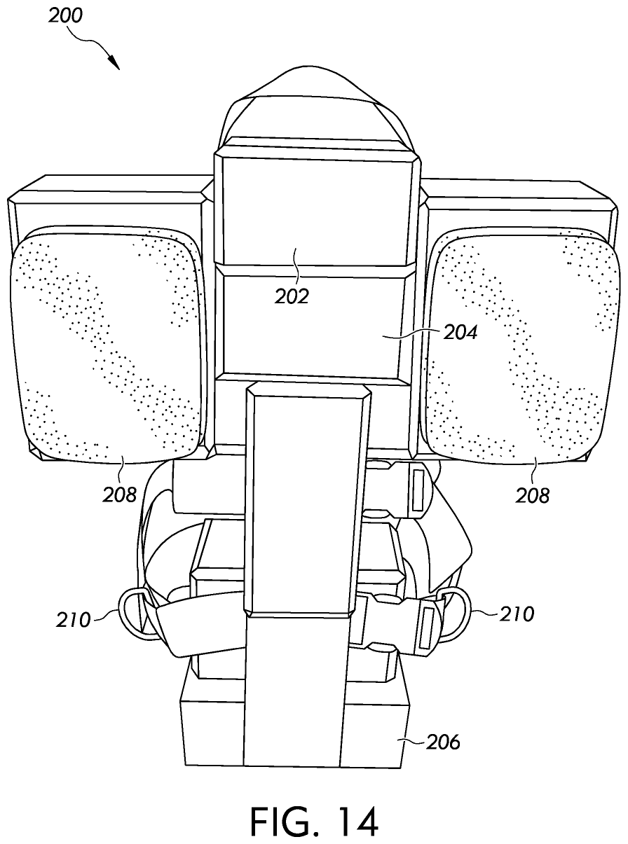

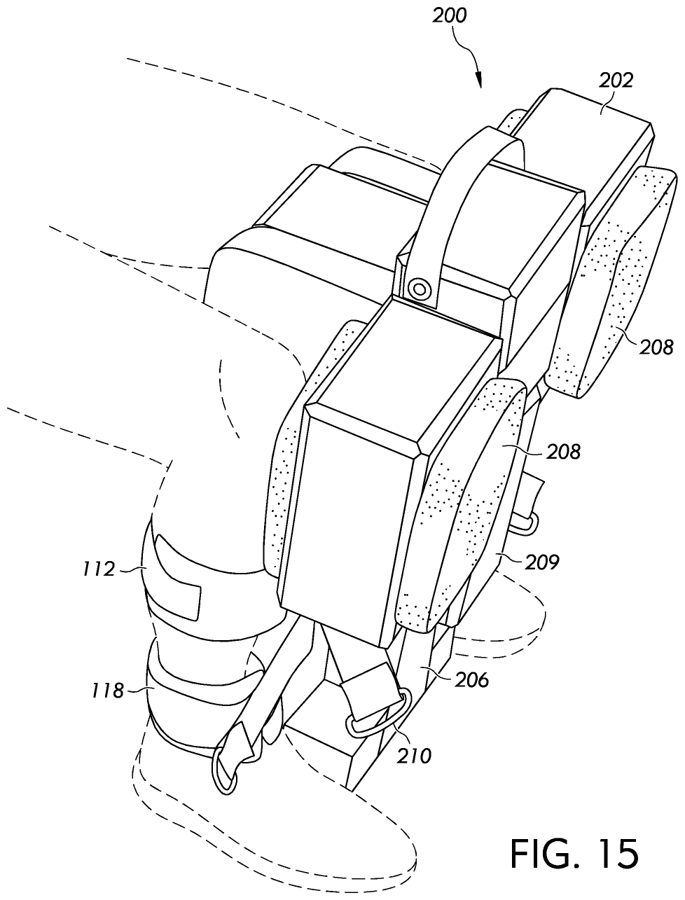

Referring now to FIGS. 1-16, the pelvis control and retraining harness system will now be discussed in more detail. The pelvis control and retraining harness system may include a pelvic harness, connective components, and other aspects. The connective components may include belts, accessories, leg members, an ankle-knee member, straps, clips, rings, and other aspects that would be appreciated by those of skill in the art after having the benefit of this disclosure. These and other aspects will be discussed in greater detail below. The pelvis control and retraining harness system may operate one or more of these components interactively with other components for a harness system. Those of skill in the art will appreciate that such system or device may be provided having a combination of one or more of the components described throughout this disclosure and may additionally include other components that would be apparent to a person of skill in the art after having the benefit of this disclosure.

The pelvis control and retraining harness system may be provided as a multi-purpose rehab and/or training system suitable for treatment of various neurological disorders, for example, traumatic brain injury (TBI), spinal cord injury (SCI), multiple sclerosis (MS), transverse myelitis (TM), and/or other neurological orders that would be apparent to a person of skill in the art after having the benefit of this disclosure. The pelvis control and retraining harness system may also facilitate treatment in certain stages of physical therapy, for example, as may be related to orthopedic post-surgical rehabilitation.

The pelvis control and retraining harness system advantageously provides versatility to facilitate a therapist or trainer to assist a patient using substantially safe practices for training and rehabilitation that would encourage measurable outcome progress toward their recovery. In one embodiment of the pelvis control and retraining harness system, one or more components could advantageously be used for home for training or assisted activities of daily living. By permitting home training, the pelvis control and retraining harness system may advantageously improve the treatment and enjoyment of life for patients, their helpers, and caregivers.

The pelvis control and retraining harness system may be used by a trainer, therapist, caregiver, or other person to help a patient perform desired physical tasks, movements, and exercise. Provided for illustrative purposes and without limitation, example movements and exercise may include sitting with proper posture, sit to stand, stand, stand to sit, crawl, supine bridging, tall kneeling, quadruped positions, providing safety during gait over-ground walking, or help with transfers. The design of the pelvis control and retraining harness system permits levels of assistance to vary or provide resistance if needed, depending on a patient's physical abilities, impairment, patient's recovery, or progression. Additionally, the pelvis control and retraining harness system may be used as a self-training tool, such as to assist with supine bridging, or could be used as resistive tool combining it with different type of equipment such as pulley/cable resistance training machines.

The pelvis control and retraining harness system advantageously provides a physical training and rehabilitation tool to a patient having limited physical abilities in different positions without needing the typically required and currently available expensive equipment. A pelvis control and retraining harness system enabled by this disclosure additionally may allow multi-use exercise to facilitate a dynamic way of training and may add more efficiency of purpose, for example, as more interventions could be used during single training session without requiring a significant investment of time with setting up complex machinery or tools.

The pelvic harness will now be discussed in greater detail. FIGS. 1-16 highlight examples of the pelvic harness, which may also be shown in other figures. The pelvic harness may be removably installable to a lower back region to assist with performance of physical activities, for example, physical training, exercise, and/or rehabilitative activities.

Generally, the pelvic harness 10 may include a harness member 20 and other components installable to and are operable with the harness member 20. The harness member 20 may include a harness middle portion 22, harness waist member 24, and harness thigh member 26. In one embodiment, the pelvic harness 10 will include two harness waist members 24 extending out in opposite directions from the harness middle portion 22 and two harness thigh members 26 extending outwardly from the harness middle portion 22. In one embodiment, the harness waist members 24 may have a harness waist member width that substantially continually decreases in width as a distance from the harness middle portion increases. In an additional embodiment, the harness thigh members 26 may have a harness thigh member width that substantially continually decreases in width as a distance from the harness middle portion increases.

The harness middle portion 22 may align near the lower back region of a user when worn. The harness waist member 24 may extend outwardly from the harness middle portion 22, terminating at an end distal to the harness middle portion 22. When worn by a user, the harness waist member 26 may at least partially pass around a waist region of the body of the user. The harness thigh member 26 may extending outwardly from the harness middle portion 22, terminating at an end distal to the harness middle portion 22. When worn by a user, the harness thigh member 28 may at least partially pass around a thigh region of the body of the user.

A strap holding member 30 may be installed to the harness middle portion 22. The strap holding member 30 may include a first hook and loop interface to interact with and removably connect to one or more other components of a system enabled by this disclosure. For example, a lumbar support strap 32 may be provided with a second hook and loop interface that is removably installable to the first hook and loop interface of the strap holding member 30 of the harness member 20. By providing the hook and loop interfaces, sliding movement of the lumbar support strap 32 may be reduced upon installing the lumbar support strap 32 to the harness member 20 via the strap holding member 30. In an alternative embodiment, the harness member 20 may additionally interface with a lumbar thoracic belt 34, such as will be discussed in greater detail below.

The harness member 20 may additionally include a handle 40 installed to the harness member 20. The handle 40 may be constructed from a piece of fabric and/or other material installed to the harness member 20, for example, via stitching. In at least one embodiment, the handle member may also include an outer handle member, which may substantially enclose at least part of the handle strap included by the handle 40. In this embodiment, the handle strap may be passed through an open handle interior space of the outer handle member to form the handle 40.

The pelvic harness 10 may include a thigh strap 50 installed to the harness thigh member 26 of the harness member 20. A first thigh strap attachment interface may be adjustably installed to the thigh strap 50 to facilitate attachment of the pelvic harness 10 to a user when worn. A corresponding second thigh strap attachment interface 54 may be installed to the harness waist member 26 to selectively connect to the first thigh strap attachment interface 52. In an example, provided without limitation, a user may wear a pelvic harness 10 enabled by this disclosure by at least wrapping a portion of the harness thigh member 26 and attached thigh strap 50 around a thigh region of the user's body. The first thigh strap attachment interface 52 attached to the thigh strap 50 may be removably connected to the second thigh strap attachment interface 54 installed to the harness member 20, thus substantially encircling the pelvic harness 10 to the thigh region of the user. The length of the thigh strap 50 and/or other straps may be adjustable, for example, via a sliding buckle. The attachment interfaces 52, 54 may be provided as male and female clips, hook and loop fasteners, loops, and carabiners, and/or another attachment interface that would be appreciated by a person of skill in the art after having the benefit of this disclosure.

In one embodiment, a ring strap securing interface 60 may be installed to the harness member 20, for example, at a harness middle portion 22. The ring strap securing interface 60 may include ends that are installed to the harness member 20 and a length of material that is loose to provide a passageway between the strap of the ring strap securing interface 60 and the material of the harness member 20. A ring strap may be pass at least partially through this passageway, thus providing increased functionality of a system enabled by this disclosure in operation.

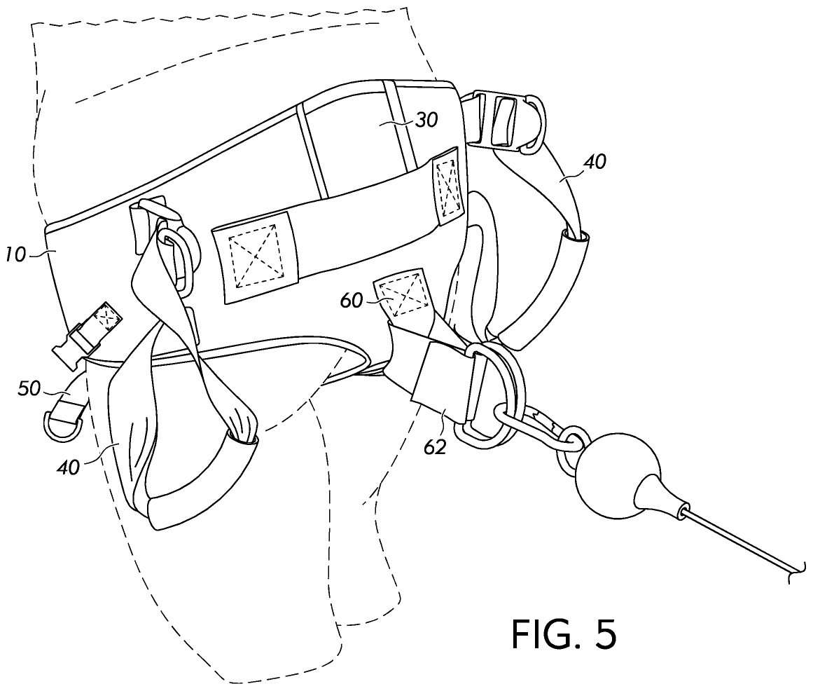

The ring strap 62 may include rings at its distal ends. The rings may be constructed using metal, plastics, synthetics, natural materials, or otherwise without limitation. External equipment may interface with the rings of the ring strap 62, and thus by extension the pelvic harness. An illustrative connection is shown in FIG. 5, without limitation.

The pelvic harness 10 may additionally include an accessory attachment interface 70, which may be installed on the harness waist member 24 of the harness member 20 to receive at least one connective component. Illustrative connective components 80 may include buckle straps 82, loop straps 84, D-ring straps 86, inguinal pads 87, attachable handles 88, mounting sleeves 89, and other components that would be apparent to skilled artisans after having the benefit of this disclosure. For example, the mounting sleeve 89 may be removably installed to a protruding member of another device, such as exercise equipment, to provide an anchoring point for the pelvic harness 10, for example, via a strap. Additionally, other components discussed throughout this disclosure may be operatively connected to the pelvic harness 10 via the attachment interface 70, such other components including, without limitation, a lumbar thoracic belt, lumbar support strap, ankle and thigh strap system, feet, and knee support system, and/or other components.

In the interest of clearly providing examples of possible configurations of a pelvic harness 10, the following illustrative embodiments will be discussed without limitation. In this example, the pelvic harness may be placed on the patient's ASIS (Anterior Superior Iliac Spine). The pelvic harness may include back and side handles attached, which handles the trainer or therapist may grab onto and hold onto. A removable strap may also be used in connection with the pelvic harness. Vertically attached loops may be used to secure the proper positioning of this strap. A buckle may allow for the removal of this strap if needed. This strap may be adjustable in length. This removable, adjustable strap may be used by the trainer or therapist to provide manual assistance and/or resistance to the patient.

A female portion of a buckle may be present on the left and right side of the harness and may serve to connect the pelvic harness to ankle cuffs using a strap. Such arrangement of components may be beneficial, without limitation, to stabilize a patient's feet and ankles, which may prevent the patient's feet and ankles from slipping away forward from a patient's pelvis.

Back and side handles of the pelvic harness may allow a trainer or therapist to provide the patient with security or assistance by grabbing onto the back or side handles during walking activities and by catching the patient if the patient loses their balance or if their legs give in. The back and side handles of the pelvic harness may also allow for the trainer/therapist to provide support or assistance to the patient in the pelvic region during activities such as, without limitation, standing, sit-to-stand exercises, stand-to-sit exercises, tall kneeling, and quadrupled positions.

The pelvic harness may also comprise vertical grip handles. These vertical grip handles may be used by the therapist/trainer to provide a patient with assistance during quadrupled or crawling activities. The vertical grip handles may include a female portion. The female portion may be used to attach a horizontal strap in the front of the harness. The horizontal strap may be useful in allowing for a therapist, trainer, or caregiver to assist the patient from the front during sit-to-stand, stand-to-sit, or standing balance activities.

The pelvic harness may also comprise thigh straps. The thigh straps may comprise a male portion of a buckle and a tension adjustment ring. The male component may extend from a patient's gluteal regions in the left and right groin and connect to a diagonally pointing female portion of a buckle on both sides of the harness. The foregoing arrangement of components may allow for a patient to be secured or spotted in the case of an actual or potential fall. Further, the arrangement of components may help to keep the pelvic harness in place upon the patient.

The pelvic harness may be constructed using virtually any number of materials. In one embodiment, provided in the interest of clarity and without limitation, the pelvic harness may be made of a two-layer neoprene material with three-ply ultrex fabric in between the two layers. This structure may provide a durable construction for the harness while at the same time being soft and cushioning to the patient's body.

The pelvic harness may further comprise a rounded top portion comprised of soft hook-and-loop fasteners. This rounded top portion may serve as an attachment point for a lumbar-thoracic belt wearable by a patient, which may further include a pocket. The pocket may be used to attach and hold an accessory, such as an e-stimulator battery for when exercises and other activity of the nature described herein may be carried out in combination with electrical stimulation. The rounded portion of the pelvic harness may also be used as a handle for a trainer or therapist to secure or assist the patient in connection with activities designed to strengthen, stabilize, or balance the patient's trunk and otherwise when trying to improve trunk/pelvic kinematics, for example when engaging in short sitting.

The connective components will now be discussed in greater detail. FIGS. 1-16 highlight examples of the connective components, which may also be shown in other figures. The connective components may include belts, clips, loops, pockets, extensions, straps, interfaces, and other components that would be apparent to a person of skill in the art after having the benefit of this disclosure. The connective components 80 may be operatively attached to the harness member 20, for example, via the accessory attachment interface 70, handle 40, strap holding member 30, and/or another interface or feature discussed throughout this disclosure. Some illustrative connective components will now be discussed by way of example and without limitation.

The connective components may include belts and straps, such as the support straps 32 and/or lumbar thoracic belt 34 and lumbar support straps. For example, the connective components may be removably installable to the pelvic harness 10 and include a lumbar support strap 34 removably attachable to the pelvic harness 10, for example, via the strap holding member 30. A ring strap 62 may be removably connected to the pelvic harness 10 via passing through the ring strap securing interface 60. Furthermore, the lumbar support strap 32 may include lumbar support rings installed at its lumbar support ends. In the interest of clarity, examples of connective components will be discussed in more detail below, without limitation.

In one example, the connective components may include a trainer and/or therapist's belt. The trainer's belt may include various parts, for example, a belt portion, a pelvis support strap, and/or other parts that would be appreciated by a person of skill in the art after having the benefit of this disclosure. A pelvis support strap may be detachable from the belt. The pelvis support strap may further include vertical loops, for example, two vertical loops, that may hold the belt in place and prevent it from sliding down. The pelvis support strap may further include a hook-and-loop strap to attach the strap with the belt portion. In one embodiment of the trainer's belt, the hook-and-loop strap may be approximately 7.5 inches long and approximately 1.5 inches wide, without limitation. Skilled artisans will appreciate additional configurations of straps that may be included using fasteners other than hook-and-loop after having the benefit of this disclosure, without limitation. The above-referenced pelvis support strap may further comprise a female portion. The female portion may attach to a corresponding male portion of a lumbar thoracic belt. Skilled artisans will appreciate that the female and male portions of a clip or other connection interface may be swapped or otherwise alternatively configured, without limitation.

In one example, the connective components may include the lumbar thoracic belt. The lumbar thoracic belt may be used in connection with the pelvic harness. The lumbar thoracic belt may be operatively attached to the pelvic harness, for example, through the soft hook-and-loop portion of the pelvic harness referenced above. The lumbar thoracic belt may optionally include a rough portion for this purpose.

In another example, the lumbar thoracic belt may be operatively connected to female or male buckle straps to train a patient to sit in short position, work on postural control, improve static and dynamic balance for short or long sitting, and/or other physical activities. Combining with female- or male-buckle loop straps during walking on treadmill or over a ground surface using mobile body weight support systems may advantageously allow securing a patient's pelvis and promotes safety. This combination may additionally help with efficient stepping, helping to promote better hip extension and terminal stance phase of stepping.

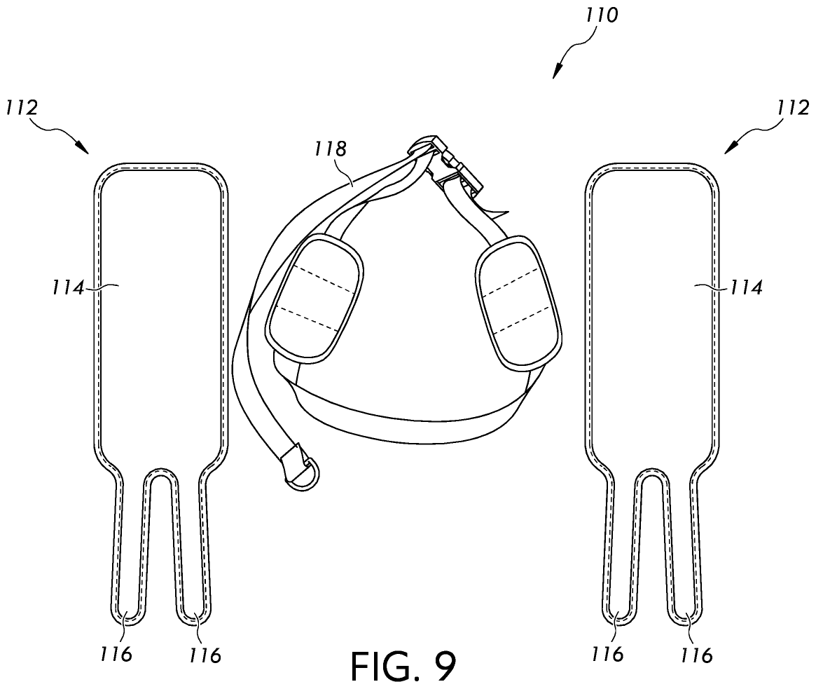

In another example, the connective components may include a leg member 110, which will now be discussed along with the following examples. In one embodiment, the leg member 110 may include a leg cuff 112 and a leg strap 118. The leg cuff 112 may at least partially pass around a leg region of the body, for example, removably encircling a part of the leg of a user. The leg strap 118 may be removably attached to the leg cuff 112 via passing through a leg cuff sleeve 119 attached to the leg cuff 112. Examples of this connection can be seen in FIGS. 9-12.

In one embodiment, the leg cuff 112 may include a leg cuff body member 114 and a leg cuff securing member 116 extending outwardly from the leg cuff body member. The leg cuff body member 114 may have a first leg cuff attachment interface, which may correspond with and operatively, removably attach to a second leg cuff attachment interface provided by the leg cuff securing member 116. The first leg cuff attachment interface and the second leg cuff attachment interface may be removably joinable to secure the leg cuff to the leg region, for example, at an ankle, calf, or thigh.

An illustrative configuration of the leg member 110 will now be discussed, without limitation. The leg member may be used to prevent or reduce the likelihood of ankles from rolling while working with clients that have impaired motor output and control in an ankle joint. The leg member may additionally be used to provide support to the upper legs, above knees, at joints, and prevent legs from abducting. The leg member can be used for facilitation and manual resistance to the ankle or knee and hip joint. Hook and loop fastener pads may be provided, which may be attached to the leg cuffs to permit a change in direction of pulling and prevents or reduce the likelihood of the strap from sliding from a desired position.

In one example, the connective components may include an ankle-knee member, which will be discussed below along with the following examples. The ankle-knee member 200 may include an ankle-knee member body, surface padding 208, an ankle-knee member strap attachment interface 210, and/or other components that would be appreciated by a person of skill in the art after having the benefit of this disclosure. The ankle-knee member 200 may include a top ankle-knee member body portion 202, which may be defined as having a first ankle-knee member width. The ankle-knee member 200 may additionally include a bottom ankle-knee member portion 206, which may be defined as having a second ankle-knee member width that is less than the first ankle-knee member width. Furthermore, the ankle-knee member 200 may include a middle ankle-knee member body portion 204, which may be defined as having a third ankle-knee member width that is less than the second ankle-knee member width, and thus also less than the first ankle-knee member width. Those of skill in the art will appreciate additional width configurations that would be included within the scope and spirit of this disclosure, without limitation. The surface padding 208 may be applied to at least part of the body of the ankle-knee member 200. An ankle-knee member strap attachment interface 210 may be provided to receive the connective components, such as those discussed in the examples above.

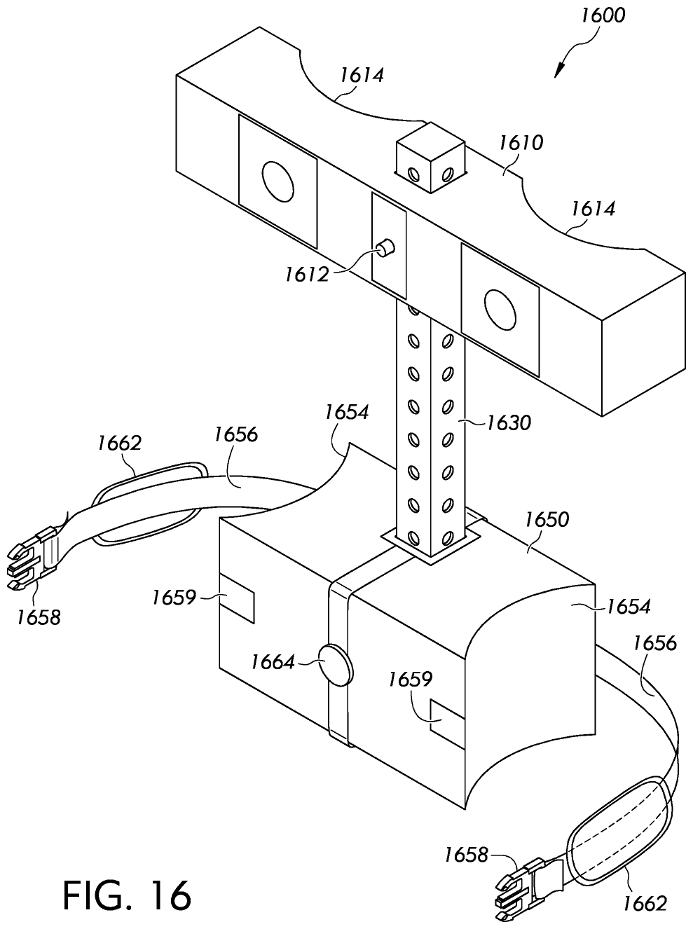

An illustrative configuration of the ankle-knee member 1600 will now be discussed along with FIG. 16, without limitation. In this example, an ankle-knee member may include various subcomponents interoperable to assist with supporting feet, knees, and other portions of a patient and/or therapist during the provision of physical therapy or other therapeutic procedures. The ankle-knee member may include an upper base 1610 and a lower base 1650, which may be operatively connected via a length vertical column 1630. In one embodiment, the length vertical column 1630 may insert at least partially into an approximately center point on inward-facing surfaces of the upper base and/or the lower base. In one embodiment, the length vertical column may extend through the upper base 1610 and/or the lower base 1650, as it may be adjusted to accommodate a desired distance between the upper base 1610 and the lower base 1650. In one embodiment, the length vertical column 1630 may be fixed to the lower base 1650 and/or the upper base 1610. A vertical knob may be included by the upper base to assist with adjusting the distance between the upper base and the lower base via the length vertical column. In operation, a user may manipulate the vertical adjust knob 1612 to affect a distance between the upper base 1610 and the lower base 1650.

The upper base 1610 may include an opening 1614 for a knee joint. This opening 1614 may be at least approximately semi-circular in construction, without limitation. Those of skill in the art will appreciate additional shapes and configurations that could be used for creating an opening 1614 for the knee joint after having the benefit of this disclosure, which are intended to be included within the scope of this disclosure.

The lower base 1650 may include an ankle joint placement aspect 1654 to assist with securing the lower base 1650 to a portion of a user, such as an ankle region. An ankle support strap 1656 may be operatively attached to a portion of the lower base 1650 such that the ankle support strap 1656 may wrap around the ankle or other portion of a user and connect to a second location on the lower base 1650. In one example, the ankle support strap 1656 may include a buckle portion 1658, such as a male buckle portion, that may be received by the lower base 1650, such as by a female buckle portion 1659 attached to the lower base. An ankle support pad 1662 may be included and operatively connected to the ankle support strap 1656, without limitation. A width adjustment knob 1664 may be included on the lower base 1650 to assist with manipulating a desired width of the lower base 1650 to improve operation and comfort of a user during operation.

An additional embodiment of an ankle-knee member will now be discussed in greater detail, without limitation. This example of an ankle-knee member may provide added stability and improved alignment in a patient's ankle, lower leg, and upper leg during certain exercises and other activities. The activities may include, without limitation, sit-to-stand exercises, standing, and stand-to-sit exercises.

A knee support base may assist with keeping the knee joint and upper thigh stable. Further, thigh and knee openings may be used to keep a patient's legs secure and properly aligned. An up/down release button may be included for locking/unlocking a height adjustment bar. This arrangement of components may allow for the knee support base to be positioned on a patient's knee. The inside portion of a patient's upper leg/knee opening may allow for a patient's knee joint to move substantially freely and provide proper kinematics of the patella. A floor base may also be included. The floor base may provide stability to the device and may prevent ankle joints from inversion/eversion when an ankle support strap is used and attached to the floor base. Trainer/therapist's knee pads may have rough hook-and-loop spots that may attach to soft hook-and-loop spots located on the knee support base.

In operation, a method may be provided for assisting with rehabilitation of pelvic and other areas of a user. Those of skill in the art will appreciate that the following methods and example uses are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional uses and methods are intended to be included by this disclosure.

In an illustrative method enabled by this disclosure, a multi-purpose rehabilitation and retraining system may be used for rehabilitating and retraining patients exhibiting a range of different neurological disorders. Such disorders may include, without limitation, Cerebral palsy, amyotrophic lateral sclerosis (ALS), multiple sclerosis (MS), traumatic brain injury, spinal cord injury, transverse myelitis, and muscular dystrophy. The method may additionally be used in connection with the rehabilitation and retraining of patients after their having undergone orthopedic surgery. The method may include facilitating rehabilitation and retraining exercises that reduce or minimize a probability of a patient re-injuring themselves while engaging in such activity. This versatility and the attendant benefits thereof may provide a foundation for achieving measurable improvements in a patient's progress while undergoing rehabilitation and retraining.

In an illustrative method, a system enabled by this disclosure may be used in one's home in connection with conducting rehabilitation and retraining exercises. An illustrative system may also be used in one's home to assist with accomplishing daily activities thereby making such activities safer and easier for patients and/or their caregivers.

Another purpose provided by this disclosure may facilitate use by a trainer, physical therapist, or caregiver to help a patient perform certain specific physical tasks or movements. Such physical tasks or movements may include, without limitation, sitting with proper posture, sit-to-stand exercises, standing, stand-to-sit exercises, crawling, supine bridging, tall kneeling, and quadruped positions. The method may also provide added safety when a patient undertakes gait-over-ground walking. A system enabled by this disclosure may also help the patient accomplish transfers, i.e., moving from the sitting to the standing position or moving from one seated surface to another.

A system enabled by this disclosure may allow a trainer, physical therapist, or caregiver to provide varying levels of assistance to a patient in accomplishing a particular movement. A system enabled by this disclosure may also allow the trainer, physical therapist, or caregiver to apply varying levels of resistance to the patient in connection with rehabilitation or retraining exercises. Such levels of assistance and resistance may vary depending upon a wide range of factors including, without limitation, a patient's physical abilities, the nature and magnitude of a patient's impairment, a patient's progress in their rehabilitation and retraining efforts, and how close or far a patient is to recovery.

In an illustrative method, a patient may use a system enabled by this disclosure as a self-training tool. For example, such a system may be used for self-training, without limitation, in connection with supine bridging. The system may advantageously provide suitable patients with alternative tools and techniques for engaging in rehabilitation and retraining while avoiding the need for expensive equipment.

In an illustrative method, an improvement over conventional rehabilitation and retraining systems in a number of aspects may be provided, including, without limitation, in a system that may provide for a more dynamic range of exercises. This illustrative system may also provide for greater efficiency by drastically reducing the amount of time required to set-up, remove, and transport conventional equipment used for the same general rehabilitation and retraining purposes.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A physical training assistance system comprising:
a pelvic harness removably installable to a lower back region of a body comprising:
a harness member comprising:
a harness middle portion to align near the lower back region when worn,
a harness waist member extending outwardly from the harness middle portion to at least partially pass around a waist region of the body, and
a harness thigh member extending outwardly from the harness middle portion to at least partially pass around a thigh region of the body,
a strap holding member installed to the harness middle portion,
a handle installed to the harness member,
a thigh strap installed to the harness thigh member,
a first thigh strap attachment interface adjustably installed to the thigh strap,
a second thigh strap attachment interface installed to the harness waist member to selectively connect to the first thigh strap attachment interface, and
a ring strap securing interface installed to the harness middle portion; and connective components removably installable to the pelvic harness comprising:
a lumbar support strap removably attachable to the pelvic harness via the strap holding member, and
a ring strap removably connected to the pelvic harness via passing through the ring strap securing interface.

2. The system of claim 1, wherein the harness waist member has a harness waist member width that substantially continually decreases in width as a distance from the harness middle portion increases.

3. The system of claim 1, wherein the strap holding member comprises a first hook and loop interface;
wherein the lumbar support strap comprises a second hook and loop interface removably installable to the first hook and loop interface; and
wherein sliding movement of the lumbar support strap is reduced upon installing the lumbar support strap to the harness member via the strap holding member.

4. The system of claim 1, wherein the lumbar support strap comprises lumbar support ends; and
wherein lumbar support rings are installed at the lumbar support ends.

5. The system of claim 1, wherein the pelvic harness further comprises an accessory attachment interface installed on the harness waist member to receive at least one of the connective components.

6. The system of claim 1, the connective components further comprising:
a leg member comprising:
a leg cuff to at least partially pass around a leg region of the body, and
a leg strap removably attached to the leg cuff via passing through a leg cuff sleeve attached to the leg cuff.

7. The system of claim 6, wherein the leg cuff comprises:
a leg cuff body member having a first leg cuff attachment interface; and
a leg cuff securing member extending outwardly from the leg cuff body member having a second leg cuff attachment interface; and
wherein the first leg cuff attachment interface and the second leg cuff attachment interface are removably joinable to secure the leg cuff to the leg region.

8. The system of claim 1, further comprising an ankle-knee member comprising:
an ankle-knee member body comprising:
a top ankle-knee member body portion having a first ankle-knee member width,
a bottom ankle-knee member portion having a second ankle-knee member width that is less than the first ankle-knee member width, and
a middle ankle-knee member body portion having a third ankle-knee member width that is less than the second ankle-knee member width;
a surface padding applied to at least part of the ankle-knee member body; and
an ankle-knee member strap attachment interface to receive the connective components.

9. The system of claim 1, wherein the handle further comprises:
a handle strap installed to the harness member;
an outer handle member substantially enclosing at least part of the handle strap; and
wherein the handle strap is passed through an open handle interior space of the outer handle member to form the handle.

10. A physical training assistance system comprising:
a pelvic harness removably installable to a lower back region of a body comprising:
a harness member comprising:
a harness middle portion to align near the lower back region when worn,
a harness waist member extending outwardly from the harness middle portion to at least partially pass around a waist region of the body, and
a harness thigh member extending outwardly from the harness middle portion to at least partially pass around a thigh region of the body,
a strap holding member comprising a first hook and loop interface installed to the harness middle portion,
a handle installed to the harness member,
an accessory attachment interface installed on the harness waist member to receive at least one of the connective components, and
a ring strap securing interface installed to the harness middle portion; and connective components removably installable to the pelvic harness comprising:
a lumbar support strap comprising a second hook and loop interface removably installable to the first hook and loop interface, the lumbar support strap being removably attachable to the pelvic harness via the strap holding member,
a ring strap removably connected to the pelvic harness via passing through the ring strap securing interface, and
a leg member comprising:
a leg cuff to at least partially pass around a leg region of the body, and
a leg strap removably attached to the leg cuff via passing through a leg cuff sleeve attached to the leg cuff.

11. The system of claim 10, wherein the harness waist member has a harness waist member width that substantially continually decreases in width as a distance from the harness middle portion increases.

12. The system of claim 10, wherein the pelvic harness further comprises:
a thigh strap installed to the harness thigh member;
a first thigh strap attachment interface adjustably installed to the thigh strap; and
a second thigh strap attachment interface installed to the harness waist member to selectively connect to the first thigh strap attachment interface.

13. The system of claim 10, wherein the leg cuff comprises:
a leg cuff body member having a first leg cuff attachment interface; and
a leg cuff securing member extending outwardly from the leg cuff body member having a second leg cuff attachment interface; and
wherein the first leg cuff attachment interface and the second leg cuff attachment interface are removably joinable to secure the leg cuff to the leg region.

14. The system of claim 10, further comprising an ankle-knee member comprising:
an ankle-knee member body comprising:
a top ankle-knee member body portion having a first ankle-knee member width,
a bottom ankle-knee member portion having a second ankle-knee member width that is less than the first ankle-knee member width, and
a middle ankle-knee member body portion having a third ankle-knee member width that is less than the second ankle-knee member width;
a surface padding applied to at least part of the ankle-knee member body; and
an ankle-knee member strap attachment interface to receive the connective components.

15. A method of physical training using a physical training assistance system, the method comprising:
(a) removably installing a pelvic harness to a lower back region of a body, the pelvic harness comprising:
a harness member comprising:
a harness middle portion to align near the lower back region when worn,
a harness waist member extending outwardly from the harness middle portion to at least partially pass around a waist region of the body, and
a harness thigh member extending outwardly from the harness middle portion to at least partially pass around a thigh region of the body,
a strap holding member installed to the harness middle portion,
a handle installed to the harness member, and
a thigh strap installed to the harness thigh member;
(b) adjustably installing a first thigh strap attachment interface of the thigh strap to a second thigh strap attachment interface of the harness waist member;
(c) selectively connecting a ring strap to the pelvic harness via passing through a ring strap securing interface of the harness middle portion; and
(d) removably installing connective components to the pelvic harness, the connective components comprising:
a lumbar support strap removably attachable to the pelvic harness via the strap holding member and,
the ring strap.

16. The method of claim 15, wherein the strap holding member comprises a first hook and loop interface, the method further comprising:
(e) removably installing the lumbar support strap to the pelvic harness via attaching a second hook and loop interface of the lumbar support strap to the first hook and loop interface; and
wherein sliding movement of the lumbar support strap is reduced upon installing the lumbar support strap to the harness member via the strap holding member.

17. The method of claim 15, further comprising:
(f) installing lumbar support rings at lumbar support ends of the lumbar support strap.

18. The method of claim 15, further comprising:
(g) installing at least one of the connective components to the pelvic harness via an accessory attachment interface of the harness waist member.

19. The method of claim 15, the connective components further comprising:
a leg member comprising:
a leg cuff to at least partially pass around a leg region of the body, further comprising:
a leg cuff body member having a first leg cuff attachment interface, and
a leg cuff securing member extending outwardly from the leg cuff body member having a second leg cuff attachment interface;
a leg strap removably attached to the leg cuff via passing through a leg cuff sleeve attached to the leg cuff; and
the method further comprising:
(h) removably joining the first leg cuff attachment interface and the second leg cuff attachment interface to secure the leg cuff to the leg region.

20. The method of claim 15, further comprising:
(i) removably installing an ankle-knee member to the pelvic member;
wherein the ankle-knee member comprises:
an ankle-knee member body comprising:
a top ankle-knee member body portion having a first ankle-knee member width,
a bottom ankle-knee member portion having a second ankle-knee member width that is less than the first ankle-knee member width, and
a middle ankle-knee member body portion having a third ankle-knee member width that is less than the second ankle-knee member width,
a surface padding applied to at least part of the ankle-knee member body, and
an ankle-knee member strap attachment interface to receive the connective components.
